(19) United States
(12) Patent Application Publication
(10) Pub. No.: US 2023/0134757 A1
(43) Pub. Date: May 4, 2023

(54) PROCESSING BIPOLAR RADAR DATA VIA CROSS SPECTRAL ANALYSIS

(71) Applicant: NOVIMET, MONTIGNY-LE-BRETONNEUX (FR)

(72) Inventors: Jacques TESTUD, Paris (FR); Erwan LE BOUAR, Montreuil (FR)

(21) Appl. No.: 17/974,595

(22) Filed: Oct. 27, 2022

(30) Foreign Application Priority Data
Oct. 28, 2021 (FR) 2111477

(51) Int. Cl. G01S 13/95; G01S 13/90

(52) U.S. Cl. CPC G01S 13/95; G01S 13/9076; G01S 13/9047

(57) ABSTRACT

The invention concerns processing which implements the following steps to estimate polarimetric parameters:
In the cross power spectrum, identifying signal-containing lines and lines only containing noise;
From the power spectra of each channel and from the cross power spectrum, deleting lines at the frequencies identified as only containing noise in the cross power spectrum;
Calculating polarimetric parameters as a function of the power spectra thus corrected.
Application to weather radars and other types of bipolar radars having coherent reception.

### GENERAL TECHNICAL FIELD AND PRIOR ART

The present invention concerns bipolar radars.

Advantageously it finds application in weather radars, but also in the detection of point targets (drone, aircraft, missile), or for remote sensing of the earth's surface.

Dual polarization weather radar (or dual pol) has become established in all C-band (5.35 GHz) and S-band (3 GHz) radar networks of national weather offices. The multiplicity of parameters to which it gives access allows better description of rain systems (distinguishing between types of hydrometeors), and quantitative estimation of precipitation with increased accuracy.

Dual polarization has also allowed the re-emergence of X-band weather radars (9.3 GHz), which had previously been set aside from operational application for reasons due to attenuation of the radar wave when propagating through heavy rain. One basic parameter measured by weather radar is in fact the reflectivity factor Z expressed in mm6/m3 (sum of effective cross-sections of raindrops within the scatter volume), or in dBZ(Z dBZ=10 log10(Z)). Z becomes highly negatively biased on X-band along pathways where strong rainfall is encountered, thereby losing any significance.

Dual polarization allows this handicap to be overcome by measuring a key parameter: the differential phase ϕDP which evolves along the pathway between the H polarization wave and V polarization wave when propagating through heavy rainfall. The round-trip attenuation of the radar wave along the pathway (in dB) is quite simply one third of the differential phase in degrees. On X-band, the corrected reflectivity in dBZ (physically interpretable directly) can be measured as apparent reflectivity in dBZ (measured by the radar) increased by ϕDP/3. This goes to show the importance of this parameter ϕDP.

Within the context of climate change, together with an increase in the frequency of extreme rainfall events causing disasters (extreme flash floods, urban runoff, landslides), there are several reasons behind the current vogue for X-band weather radar.

For performance similar to C- or S-band radar, the radar is of reduced size and can hence be installed in the heart of cities or catchment areas to be monitored.

The power balance is distinctly more favourable than for C- or S-band since the effective scattering cross-section of raindrops is proportional to D6/λ4 (D: droplet diameter, λ: radar wavelength).

The emergence on the market of the solid-state X-band transmitter has the advantage compared with the conventional magnetron transmitter of being coherent and extremely durable.

One general objective of the invention is the search for improved signal-to-noise ratio.

The peak power of the solid-state transmitter is about one hundred times weaker than that of a magnetron. To recover a signal-to-noise ratio comparable to that of the magnetron radar whilst maintaining the radial resolution of short pulses (such as 1 microsecond), several paths can be followed including improved signal processing. Fourier analysis is one possible path investigated in this patent. It applies both to pulse compression radar and to other types of coherent radar (all power tubes). The specificity of the weather radar is to use dual polarization—not used in military radars—making possible the recourse to cross spectral analysis. The potential improvement in signal-to-noise ratio on the differential phase through the use of this technique is about 6 dB.

With a dual polarization weather radar, processing of the radar signal is intended to deliver the following raw measurement parameters:

Reflectivity factor Z (attenuated) in dBZ,

Differential reflectivity factor (attenuated) ZDR (dB),

Correlation coefficient ρHV,

Differential phase ϕDP,

Radial velocity VR,

Radial velocity variance σV.

Signal processing conventionally used in weather radar is based on «pulse pair» and the Fourier Transform (FFT or DFT).

### Pulse Pair

Starting with the analytical signal s_{H}(i) for the H channel and s_{V}(i) for the V channel.

On X-band, a usual pulse repetition frequency (PRF) of the radar is 1000 Hz. A series of M pulses is processed (e.g. 64) and the coefficients of auto- and inter-correlation are calculated (where the symbol * designates the analytical product) giving:

$${C}_{H} = \frac{1}{M} {{\sum }_{i = 1}}^{M} {s}_{H} ( i ) * {s}_{H} ( i ) \\ {C}_{H + 1} = \frac{1}{M - 1} {{\sum }_{i = 1}}^{M - 1} {s}_{H} ( i ) * {s}_{H} ( i + 1 ) \\ {C}_{V} = \frac{1}{M} {{\sum }_{i = 1}}^{M} {s}_{V} ( i ) * {s}_{V} ( i ) \\ {C}_{HV} = \frac{1}{M} {{\sum }_{i = 1}}^{M} {s}_{H} ( i ) * {s}_{V} ( i )$$

The raw parameters of the radar are then calculated as follows:

Reflectivity Z:

Z=K·C_{H}·r²

Where K is the «radar constant» dependent on the characteristics of the radar and r is the radar-target distance.

Differential reflectivity ZDR

Z_{DR}=C_{H}/C_{V}

Correlation coefficient ρHV

$${ρ}_{HV} = \frac{\vert {C}_{HV} \vert}{\sqrt{\vert {C}_{H} \vert \vert {C}_{V} \vert}}$$

Differential phase

$${Φ}_{DP} = \frac{180}{π} arg ( {C}_{HV} )$$

Radial velocity

$${V}_{R} = \frac{λ PRF}{4 π} arg ( {C}_{H + 1} )$$

### Fourier Transform

The other approach routinely used is the Fourier Transform of series s_{H}(i) and s_{V}(i). Analysis of the power spectrum (calculation of moments) allows deriving of the power of the weather signal (hence reflectivity), the Doppler shift thereof (hence radial velocity), variance (hence variance in velocities in the scattering volume).

However, the Fourier Transform is not used to estimate polarimetric parameters such as differential phase and correlation coefficient. It is rather more a pre-filtering tool of undesirable signal interference (in particular ground echoes). The time domain is then again used to estimate the aforementioned physical parameters with the «pulse pair» technique.

### The Limitations of «Pulse Pair» Processing

Pulse pair is very simple and very efficient processing. It produces accurate, non-biased estimators for as long as the signal-to-noise ratio (SNR) is sufficiently high (>15 dB for 64 pulse processing). As soon as the SNR falls below 15 dB, the ϕDP and ρHV estimators deteriorate and soon become unusable as shown in FIG. 1 illustrating the accuracy of the 64 pulse «pulse pair» estimator as a function of the signal-to-noise ratio SNR. Simulation is performed for rainfall where the physical correlation coefficient is 0.99 under all circumstances. Processing considers 64 pulses. It can be seen that the uncertainty of the correlation coefficient estimator ρHV (red curve) rapidly deteriorates to reach ±0.05 at SNR of 9 dB. Bearing in mind that the correlation coefficient in melting snow is 0.95, this means that for SNRs lower than 9 dB, it is no longer possible to discern the «bright band», the signature of the melting layer allowing a distinction to be made between snow and rain. Similarly, for the ϕDP estimator (black triangles) for which uncertainty exceeds ±6° for SNR <10 dB.

Since parameter ϕDP is essential to correct the reflectivity Z of attenuation, it is detection thereof which determines the size of the signal-to-noise ratio SNR required to obtain processable data, and hence finally to estimate the range of the radar. The radar data can only be used for quantitative measurements of rain rate for as long as SNR>10 dB.

### General Description of the Invention

It is one objective of the invention to propose a solution whereby all or some of the prior art problems can be overcome.

For this purpose, it proposes a method for determining information on physical parameters observable by a bipolar radar having coherent reception, able to transmit a series of pulses and to receive and sample a return signal,

wherein at least one processing unit implements the following steps to estimate polarimetric parameters:
Determining time series of the analytical signal for both transmission channels H and V;
From these time series, calculating Fourier transforms of the analytical signal on these two channels H and V;
From these Fourier transforms, calculating the power spectra of each channel HH, VV, and the cross power spectrum HV;
In the cross power spectrum, identifying signal-containing lines and lines only containing noise;
Deleting from the power spectra of each channel and from the cross power spectrum those lines at the frequencies identified as only containing noise in the cross power spectrum;
Calculating polarimetric parameters as a function of the power spectra thus corrected, and wherein determination of information on observable physical parameters

is also implemented by processing these polarimetric parameters.

This method is advantageously supplemented by the following different characteristics taken alone or in combination:
the moments of the cross spectrum are determined and the moments are processed to identify signal-containing lines;
the moments of the HH and VV channels and those of the cross power spectrum HV are calculated after deleting lines only containing noise, and wherein the polarimetric parameters are calculated as a function of the power spectra thus corrected;
for a pulse repetition frequency PRF of the radar, determination is implemented in two configurations:
the Fourier analysis band [−PRF/4, PRF/4] is centred on zero,
the Doppler spectrum is represented over the range [0, PRF/2] and the configuration is chosen which leads to the lowest variance;
the power spectra are processed to distinguish between the «normal» echo of the first trace having the weakest differential phase, and the echo of the second trace necessarily having a greater differential phase.

The invention also concerns a computer programme product comprising instructions adapted to implement steps of the aforementioned method by at least one computer.

### BRIEF DESCRIPTION OF THE DRAWINGS

Other characteristics and advantages of the invention will become better apparent from the following description given as an illustration and nonlimiting and is to be read in connection with the appended Figures in which:

FIG. 1 is the standard error of deviation on the different radar observables—reflectivity Z, differential reflectivity ZDR, differential phase ϕDP and correlation coefficient ρHV—as a function of the signal-to-noise ratio SNR.

FIG. 2 illustrates the functional diagram of the bipolar radar 9.

FIG. 3 schematically illustrates a power spectrum associated with the

Fourier transform of signal H (or V). The analysis band of the signal is the range [−PRF/4; +PRF/4] in the frequency space or [−Vₐ; +Vₐ] in the radial velocity space (Vₐ=λ·PRF/4 with λ the wavelength of the radar).

FIG. 4 is the illustration in the analytical plane of the signal s to which noise b is added. It can be seen that when |s|/|b|=10, the phase error is 6°. In terms of signal-to-noise ratio using power for reasoning, this corresponds to S/B=20 dB.

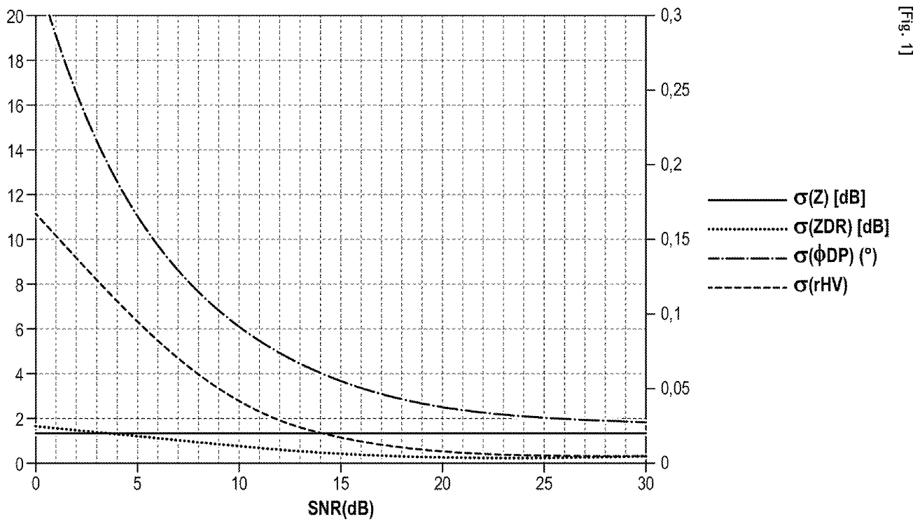

### DESCRIPTION OF ONE OR MORE EMBODIMENTS

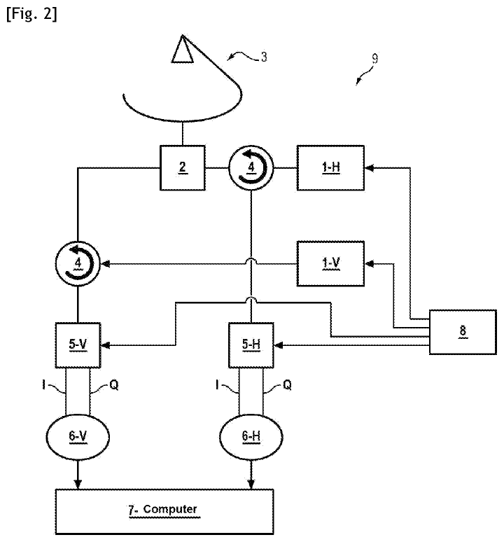

FIG. 2 illustrates a bipolar radar 9. The bipolar radar 9 can comprise:
two solid state transmitters 1-H and 1-V respectively feeding the horizontal (H) and vertical (V) polarizations of the transmission antenna;
a mode extractor (or orthomode) connected via two links to the 1-H and 1-V transmitters;
a horn antenna 3 transmitting or receiving the two polarizations;
circulators 4 (T filters) interposed on the H and V channels between the mode extractor 2 and solid state transmitters 1;
analogue receiving means 5-H and 5-V connected, for channels H and V, to the circulators 4;
an oscillator to synchronize the 1-H and 1-V transmitters and receiving means 5-H and 5-V;
sampling and processing means 6-H and 6-V of outputs I and Q of these receiving means 5, the processing means 6 allowing calculation of the Fourier transforms of the sampled series of I and Q (by FFT or DFT).

It can be noted here that, more generally, the processing proposed below applies to any other weather radar technology having coherent reception (and in particular to magnetron, klystron or travelling wave tube radars, and to bipolar FMCW radar]).

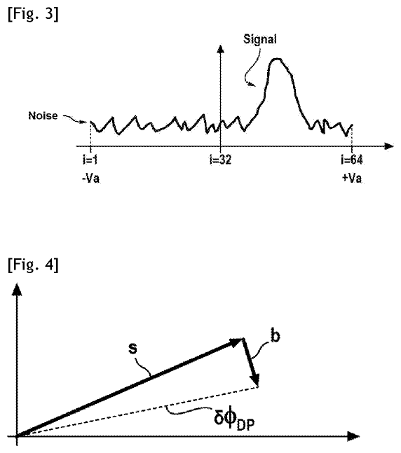

A processing computer 7 allows the calculation, from the H and V Fourier transforms, of the power spectra PHH, PVV [illustrated in FIG. 3] and PHV, and from these power spectra calculation of the observables ZH, ZDR, ρHV, ϕDP, VR, σV.

### Cross Power Spectrum

Starting with the time series of the analytical signal as in «pulse pair» processing:

{s_{H}(i)}, i=1 . . . M (1)

and

{s_{V}(i)}, i=1 . . . M (2)

The Fourier transforms of series (1) and (2) are calculated (e.g. by FFT or DFT) having taken care to apply prior windowing such as Hamming or other, which is common practice by most manufacturers of weather radars. For example, compared with the rectangular window, the Hamming window lowers the secondary side lobes of the equivalent filter to 43 dB (as against −13 dB with the rectangular window) at the cost of deteriorated spectral resolution by factor 2.

The proposed processing uses Fourier spectra. If the Fourier transforms of (1) and (2) are called FH(i) and FV(i), they are now used to calculate the corresponding power spectra.

{P_{H}(i)=F_{H}(i)*F_{H}(i)}, i=1 . . . M (3)

and

{P_{V}(i)=F_{V}(i)*F_{V}(i)}, i=1 . . . M (4)

As above, in (3) and (4) the product * designates the analytical product, and the power spectra PH(i) et PV(i) are real and positive. These power spectra can be used to estimate the power of the weather signal (hence reflectivity Z), the Doppler shift thereof (hence the Doppler velocity vR of the weather targets), and variance (hence the variance oV of Doppler velocities).

However, in PH(i) and PV(i) any information on differential phase ϕDP and correlation coefficient ρHV has disappeared.

Processing takes into consideration the cross spectrum PHV(i) in the following manner:

{P_{HV}(i)=F_{H}(i)*F_{V}(i)}, i=1 . . . M (5)

In each spectral line it can be written:

P_{HV}(i)=S_{HV}(i)+B_{HV}(i) (6)

where SHV(i) is the cross power spectrum of the weather signal and BHV(i) the noise spectrum.

### Specificities of the Cross Power Spectrum

The noise on channel H being incoherent relative to the noise on channel V, in each spectral line BHV(i) averages zero whilst the standard deviation thereof is the square root of the product of the standard deviations of BH(i) [noise on channel H] and Bv(i) [noise on channel V].

The information on ϕDP and ρHV are now in SHV(i) since:

$${Φ}_{DP} = arg ( {{\sum }_{i = 1}}^{M} {S}_{HV} ( i ) ) \qquad ( 7 )$$

$${ρ}_{HV} = \vert {{\sum }_{i = 1}}^{M} {S}_{HV} ( i ) \vert / {\vert {{\sum }_{i = 1}}^{M} {S}_{H} ( i ) \vert}^{1 / 2} {\vert {{\sum }_{i = 1}}^{M} {S}_{V} ( i ) \vert}^{1 / 2} \qquad ( 8 )$$

### Method for Determining Polarimetric Variables

The purpose of Fourier analysis is to isolate the radar signal (assumed to be a stationary Gaussian random function) of typical width ±1 m/s in the Doppler velocity space, within a spectral analysis band ±Va [Va or «ambiguous velocity» is typically 8 m/s or 16 m/s, depending upon the pulse repetition frequency of the radar]. And subsequently to determine the characteristics thereof.

FIG. 3 schematically illustrates a Doppler power spectrum obtained from a series [I,Q] of 64 bursts. One conventional technique for estimating Z, VR and σV is the moment method. For example, for channel H, by calculating the first three moments of the spectrum:

M₀=Σ₁^{M}P_{H}(i) (9)

M₁=Σ₁^{M}i, P_{H}(i) (10)

M₂=Σ₁^{M}i², P_{H}(i) (11)

we are given access to the following estimators

$$∝ {M}_{0} \qquad ( 12 )$$

$$∝ {M}_{1} / {M}_{0} \qquad ( 13 )$$

$$∝ \frac{{M}_{2}}{{M}_{0}} - {( \frac{{M}_{1}}{{M}_{0}} )}^{2} \qquad ( 14 )$$

However, these estimators are biased by remaining noise. The problem we have come up against up until now has been the thresholding of the spectrum to remove bias from the estimators. Evidently it is possible to estimate noise in the spectral lines in which we are sure there is only noise, then to threshold the spectrum to remove the noise. However, to remove noise peaks (two or three times above the average) we are compelled to threshold to a level such that the gain of Fourier analysis becomes small compared with the conventional pulse pair technique. It is this problem of thresholding the Doppler spectrum which up until now has prevented use of Fourier analysis to the benefit of pulse pair.

Cross spectral analysis allows overcoming of the thresholding problem. A cross power spectrum cannot be illustrated in a diagram such as the one in FIG. 2 since all the spectral lines thereof have complex values. Nonetheless the moment method can be considered to determine the following estimators:

$${Z}_{HV} ∝ {M}_{0} \qquad ( 15 )$$

$$∝ {M}_{1} / {M}_{0} \qquad ( 16 )$$

$$∝ \frac{{M}_{2}}{{M}_{0}} - {( \frac{{M}_{1}}{{M}_{0}} )}^{2} \qquad ( 17 )$$

where j2=−1

The major advantage of considering the cross spectrum is that it provides access to non-biased estimators since as pointed out above [symbol] B_{HV}(i) [symbol] =0 [with i=1 . . . M].

This evidently does not mean that noise is not contained in the cross spectrum. The variance thereof in each spectral line is given by:

[symbol]

(B_{HV}(i))² [symbol] = [symbol] B_{H}(i)² [symbol] − [symbol] B_{H}(i) [symbol] ²= [symbol] B_{V}(i)² [symbol] − [symbol] B_{V}(i) [symbol] ² (18)

In other words, noise variance on the HV channel is the same as on the H channel or V channel, but the average value thereof is zero.

Since the application of formulas (15), (16) and (17) allows non-biased estimation of Z_{HV}exp(iΦ_{DP}), V_{R} and σ_{V}, it is possible to identify those lines in the spectrum which contain the signal, then to discard all the spectral lines containing only noise to perform a further, more accurate calculation of moments.

In the cross spectrum, identification of the signal within the complex spectrum can be obtained as soon as the ratio «signal power» to «noise variance» exceeds 0 dB in the spectral line concerned.

For measurement of ϕDP, mere geometric consideration illustrated in FIG. 4 indicates the required signal-to-noise ratio for a given phase error.

FIG. 3, on the analytical plane, illustrates the signal s to which noise b is added. It can be seen that when |s|/|b|=10, the phase error is 6°. In terms of signal-to-noise error when reasoning is based on power, this corresponds to S/B=20 dB.

For spectral analysis, this S/B ratio must be obtained in the spectral line containing the signal. The ratio between the width of the base band of signal analysis and the width of the spectral line containing the signal being M/2 (still in the case of a Hamming window), this corresponds to a S/B ratio in the signal analysis band of 20−10·log₁₀(M/2)(dB).

With «pulse pair», it is the signal-to-noise ratio after incoherent integration that must be considered. Having regard to the fact that after integration on M−1 pairs, noise power is divided by \sqrt{M−1} to obtain a signal-to-noise ratio of 20 dB after integration, it is sufficient that the signal-to-noise ratio in the base band exceeds: 20−10·log₁₀\sqrt{M−1}(dB).

It can therefore be seen that the approach via cross spectral analysis allows a gain of:

10·log₁[(M/2)/\sqrt{M−1}](dB) in signal-to-noise ratio.

i.e. 4.6 dB for M=32, 6 dB for M=64, 7.5 dB for M=128.

Remark: The cross spectral analysis technique also allows improved detection of any of type of point or distributed targets such as drones, birds, clear-air echoes, etc . . .

### Problem Related to Spectral Folding

When the signal spectrum draws close to the limits of the analysis band [−PRF/4, PRF/4] (PRF=Pulse Repetition Frequency), the conventional approach of calculating radial velocity and variance with the moment method can lead to biases, even to aberrations (issue of spectral folding of the signal within the analysis band). One practical means of preventing this is to perform the calculation in two configurations: «natural» where the Fourier analysis band is [−PRF/4, PRF/4] centred on zero (natural outcome of Fourier transform), and «unfolded» where the Doppler spectrum is represented over the range [0, PRF/2]. By selecting the configuration leading to lowest variance, it is possible to avoid the bias phenomenon due to spectral folding when the signal line draws close to the limit.

### Gain Obtained with Cross Spectral Analysis Compared with «Pulse Pair»

Let us consider a time series of M measurement points with M=32, 64 or 128.

Let B be the noise in the base band.

Pulse pair allows noise reduction in a proportion of \sqrt{M−1}.

Cross spectral analysis, when a Hamming window is used, allows a noise gain of factor M/2 (factor 2 taking into account the fact that the Hamming window widens the Fourier analysis filter by a factor of 2). Table 1, as a function of the number of points of analysis, compares the reduction in the noise level obtained with pulse pair and with cross spectral analysis. It can be seen that, compared with pulse pair, cross spectral analysis allows a gain of 4.5 to 7.5 dB in the signal-to-noise ratio.

TABLE 1

| | | | | |
|---|---|---|---|---|
| Number of points | M | 32 | 64 | 128 |
| | linear | 0.18 | 0.13 | 0.09 |
| Pulse pair | dB | −7.53 | −9.03 | 10.54 |
| | linear | 0.06 | 0.03 | 0.02 |
| Cross spectral | dB | −12.04 | −15.05 | 18.06 |
| analysis | Gain/Pulse P. | −4.52 | −6.02 | −7.53 |

1. A method for determining information on physical parameters observable by a bipolar radar having coherent reception, able to transmit series of pulses and to receive and sample a return signal,
wherein at least one processing unit implements the following steps to estimate polarimetric parameters
Determining time series of the analytical signal for both transmission channels H and V;
From these time series, calculating Fourier transforms of the analytical signal on these two channels H and V;
From these Fourier transforms, calculating the power spectra of each channel HH, VV, and the cross power spectrum HV;
In the cross power spectrum, identifying signal-containing lines and lines only containing noise;
Deleting from the power spectra of each channel and from the cross power spectrum those lines at the frequencies identified as only containing noise in the cross power spectrum;
Calculating polarimetric parameters as a function of the power spectra thus corrected,
and wherein determination of information on observable physical parameters is also implemented by processing these polarimetric parameters.

2. The method according to claim 1, wherein the moments of the cross spectrum are determined and the moments are processed to identify signal-containing lines.

3. The method according to claim 2, wherein the moments of the HH and VV channels and those of the cross power spectrum HV are calculated after deleting lines only containing noise, and wherein the polarimetric parameters are calculated as a function of the power spectra thus corrected.

4. The method according to claim 1, wherein for a pulse repetition frequency PRF of the radar, determination is implemented in two configurations:
the Fourier analysis band [−PRF/4, PRF/4] is centred on zero;
the Doppler spectrum is represented over the range [0, PRF/2] and the configuration is chosen which leads to the lowest variance.

5. The method according to claim 1, wherein the power spectra are processed to distinguish between the «normal» echo of the first trace having the weakest differential phase, and the echo of the second trace necessarily having a greater differential phase.

6. A computer program product comprising instructions adapted to implement steps of a method for determining information on physical parameters observable by a bipolar radar having coherent reception, able to transmit series of pulses and to receive and sample a return signal,
said steps comprising the following steps to estimate polarimetric parameters
Determining time series of the analytical signal for both transmission channels H and V;
From these time series, calculating Fourier transforms of the analytical signal on these two channels H and V;
From these Fourier transforms, calculating the power spectra of each channel HH, VV, and the cross power spectrum HV;
In the cross power spectrum, identifying signal-containing lines and lines only containing noise;
Deleting from the power spectra of each channel and from the cross power spectrum those lines at the frequencies identified as only containing noise in the cross power spectrum;
Calculating polarimetric parameters as a function of the power spectra thus corrected,
and wherein determination of information on observable physical parameters is also implemented by processing these polarimetric parameters.
